(19) United States
(12) Patent Application Publication
(10) Pub. No.: US 2002/0043154 A1
(43) Pub. Date: Apr. 18, 2002

(54) Zeolite compounds for removal of sulfur compounds from gases

(75) Inventor: Lawrence Shore, Edison, NJ (US)

Correspondence Address: Chief Patent Counsel, Engelhard Corporation, 101 Wood Avenue, P.O. Box 770, Iselin, NJ, 08830-0770, US

(73) Assignee: ENGELHARD CORPORATION

(21) Appl. No.: 09/934,869

(22) Filed: Aug. 22, 2001

Related U.S. Application Data
(60) Provisional application No. 60/228,146, filed on Aug. 25, 2000.

(51) Int. Cl. B01D 53/02

(52) U.S. Cl. 95/135

(57) ABSTRACT

A method to remove sulfur compounds from a gas having up to about 30 percent propylene. The gas is contacted with a zeolite compound at greater than 75° C. The zeolite compound comprises less than 5 percent water. Useful zeolites include X, Y and faujasite. The zeolite can ion exchanged with ions such as zinc ion.

### RELATED APPLICATIONS

This application is a continuation-in-part of U.S. Provisional Application No. 60/228,146 filed Aug. 25, 2000.

### BACKGROUND OF THE INVENTION

1. Field of the Invention

The present invention relates to the field of gas treatment, and more particularly to the treatment of gases with zeolite compounds to remove sulfur compounds.

2. Background of the Invention

Organic sulfur compounds are added to commercial propane as odorants. These compounds can be removed by adsorption on a zeolite. However, unlike methane, competitive adsorption occurs with commercial liquefied petroleum gas (LPG), and the selectivity for sulfur removal is poor at room temperature.

U.S. Pat. No. 6,096,194 to Tsybulevskiy, et al. discloses the use of a zinc-exchanged faujasite as a sulfur compound adsorbent.

### SUMMARY OF THE INVENTION

The present invention is directed to a method to remove sulfur compounds from a gas having up to about 30 percent propylene, typically from 0.5 to 5% propylene, comprising contacting the gas with a zeolite compound at greater than 75° C., preferably from greater 75° C. to 200° C., more preferably from greater than 75° C. to less than 150° C., and yet more preferably from greater than 75° C. to 125° C. The zeolite compound is preferably dry and can comprise less than 5 weight percent water, more preferably less than 3 weight percent water. The method preferably further comprising the step of predrying the zeolite compound, preferably at a temperature of from 125 to 300° C. and more preferably 150 to 300° C.

A preferred zeolite is a zinc exchanged zeolite, with zinc-exchanged faujasite being most preferred. The zeolite can selected from the group consisting of X, Y and faujasite, with faujasite most preferred. Preferably, the faujasite is ion exchanged with zinc ions. More preferably, there is an excess of zinc ion above the exchangeable sites. Yet more preferably at least 8 percent of the zinc ions are present in inequivalent excess of the total ion exchange degree of the zeolite as recited in U. S. Pat. No. 6,096,194. The preferred zeolite has a low silica to alumina ratio which can be in the range of 1.8:1 to about 2.1:1.

The present invention is particularly useful to remove sulfur from liquefied petroleum gas. Such gases are predominately comprised of propane. Liquefied natural gas additionally typically comprises up to 30% of propylene. A common liquefied natural gas HD-5 LPG comprises less than 5% propylene, typically from 1-5% propylene. Where gas is comprised, sulfur compounds such as organosulfur compounds, such as mercaptan and propylene, the propylene competes with the sulfur compounds for sites on the adsorbents. At low temperatures such as ambient temperatures the concentration of propylene is much greater than that of the sulfur compounds. It has been observed that at such conditions the propylene adsorbs more favorably than sulfur on adsorbents such as zeolites. As the temperature increases the propylene becomes more mobile and therefore there is a tendency for it to be less preferentially adsorbing onto the adsorption sites compared to the sulfur compounds. It has further been found that when an adsorbent such as the zeolite is ion-exchanged, preferably with a zinc iron it becomes even more selective to adsorb sulfur in the presence of propylene. While not wishing to be bound by a theory it is believed that the presence of an ion-exchanged material, preferably zinc actually forms a secondary bond with the sulfur compound. When the temperature is increased to higher levels, typically greater than 250° C. and referably in the range of 250-400° C. the sulfur compound will be released from the zeolite. Therefore, the use of an ion-exchanged zeolite has been found to preferentially adsorb gaseous organosulfur compounds in the presence of propylene in gases containing from 1-30% propylene. The adsorbent can be regenerated by heating to temperatures in the range of 250° C. to 400° C.

### BRIEF DESCRIPTION OF THE DRAWINGS

FIG. 1 is a graph of sulfur compound adsorption versus time using a zeolite at different temperatures.

FIG. 2 is a graph of sulfur compound adsorption versus time using a zeolite at different temperatures and space velocities.

FIG. 3 is a graph of sulfur compound adsorption versus time using a zeolite at different temperatures and space velocities.

### DETAILED DESCRIPTION OF THE PREFERRED EMBODIMENTS

Natural gas (NG) and liquefied petroleum gas (LPG), which is predominantly propane, are odorized using organic sulfur compounds. Natural gas is greater than 95% methane, with remainder being C2- to C4- alkanes. LPG contains a mixture of propane and propylene, typically there is greater than 50% propane and propylene with some butane.

While these sulfur compounds serve a beneficial purpose as stenching agents, their presence in hydrocarbon fuels are a drawback. Natural gas is odorized with a variety of C3- and C4-mercaptans, as well as tetrahydrothiophene, dimethyl and methyl ethyl sulfide, while ethyl mercaptan is added to LPG. This is specifically true for fuels to be reformed into a hydrogen stream supplying a fuel cell. The organic sulfur compounds are converted to hydrogen sulfide using some variety of hydro-desulfurization process. This can occur during auto thermal reforming (ATR). ATR is a combination of high-temperature partial oxidation, followed by steam reforming. The hydrogen sulfide formed in the fuel reformer will be adsorbed, most probably irreversibly, on both downstream catalysts and the anode electrode of the fuel cell, resulting in the deactivation of the fuel reformer and/or the fuel cell.

Catalysts are used in the fuel reformer for conversion of carbon monoxide, a by-product of preliminary reforming, to the desired product, hydrogen. The composition and operating temperature of the catalysts make them susceptible to sulfur poisoning. The product stream of the fuel reformer is directed to the anode of the fuel cell, where the hydrogen is oxidized. The anode is composed of a Pt catalyst, which is also susceptible to sulfur poisoning because of the low operating temperature.

The sulfur is organically-bound, as the compounds listed above. The sulfur concentration of natural gas is about 10 ppm by volume. Prior to odorizing and shipping, the natural gas has been sweetened, by processing to remove naturally occurring sulfur compounds. HD-5 LPG is a specification for LPG which has at least 90% propane and less than 5% propylene, with some butane and in which the sulfur compound is predominantly ethyl mercaptan. The sulfur is specified to be less or equal to 123 ppm by weight, including the added odorant.

There are advantages to remove the sulfur prior to its conversion to hydrogen sulfide. The hydrocarbon stream is dry, normally a consideration in using adsorbents, and the sulfur is most concentrated at this point. It is desirable to desulfurize the fuel inlet stream to less than about 0.5 ppm. The treated gas then passes to the fuel reformer. The gas is diluted in the fuel reformer (typically during the ATR process) to about 50 ppb. The diluted gas then passes to the downstream fuel processor catalysts (e.g., WGS catalyst, selective oxidation catalyst, etc). In the absence of secondary adsorbents, this corresponds to removal of at least 95% of the incoming gaseous sulfur compounds, based on use of either NG or LPG. Less than 90% sulfur removal, especially with a practically-sized bed (space velocity (SV) of 200-1000) would be considered as poor removal. The downside of this process is the variety of odorants that are used in the stenching process. This complicates the identification of a single material for treatment of different gas streams.

Experience has shown that organic sulfur compounds of the type present in NG or LPG can be efficiently removed from natural gas with some zeolites at room temperature. Under the same conditions, poor removal of organic sulfur from vaporized LPG is achieved. In the course of this study, several zeolites have been compared, and it has been discovered that near-quantitative removal of sulfur can be achieved at elevated temperature.

Zeolites particularly suitable for use in accordance with the invention include the following structure types: X, Y, faujasites, pentasils, mordenites, ZSM-12, zeolite beta, zeolite L, zeolite omega, ZSM-22, ZSM-23, ZSM-48, EU-1, etc. The X, Y and faujasites zeolites are preferred and preferably have a low SiO₂ to Al₂O₃ ratio, which can be less than about 25, preferably from 1 to 25, and more preferably from 1 to 5. A useful and preferred faujasite has silica to alumina ratio which can be in the range of 1.8:1 to about 2.1:1

Zeolites can be characterized by general formula (I):

M¹n[mM²O₂.nSiO₂].qH₂O (I)

in which

M¹ is an equivalent of an exchangeable cation corresponding in number to the M² component;

M² is a trivalent element which, together with the Si, forms the oxidic skeleton of the zeolite;

n/m is the SiO₂ to M²O₂ ratio and

q is the quantity of absorbed water.

In terms of their basic structure, zeolites are crystalline aluminosilicates which are made up of a network of SiO₄ and M²O₄ tetrahedrons. The individual tetrahedrons are attached to one another by oxygen bridges via the corners of the tetrahedrons and form a three-dimensional network uniformly permeated by passages and voids. The individual zeolite structures differ from one another in the arrangement and size of the passages and voids and in their composition. Exchangeable cations are incorporated to compensate the negative charge of the lattice which arises out of the M² component. The absorbed water phase qH₂O is reversibly removable without the skeleton losing its structure. M² is often aluminum, although it may be partly or completely replaced by other trivalent elements.

A detailed description of zeolites can be found, for example, in the book by D. W. Breck entitled “Zeolite Molecular Sieves, Structure, Chemistry and Use”, J. Wiley & Sons, New York 1974. A further description, particularly of high-silica zeolites suitable for catalytic applications, can be found in the book by P. A. Jacobs and J. A. Martens entitled “Synthesis of High-Silica Aluminosilicate Zeolites”, Studies in Surface Science and Catalysis, Vol. 33, Ed. B. Delmon and J. T. Yates, Elsevier, Amsterdam-Oxford-New York-Tokyo, 1987.

In the zeolites used in accordance with the invention, M² can be one or more elements selected from the group consisting of Al, B, Ga, In and Fe and preferably one or more elements from the group consisting of Al, B, Ga and Fe, with Al most preferred.

The exchangeable cations M¹ present in the zeolites mentioned may be, for example, those of H, K, Mg, Ca, Sr, Ba, Zn and also other transition metal cations. Cations of the rare earth group are also suitable. Preferably, the zeolite is ion exchanged with zinc ions. More preferably, there is an excess of zinc ion above the exchangeable sites. Yet more preferably at least 8 percent of the zinc ions are present in inequivalent excess of the total ion exchange degree of the zeolite as recited in U.S. Pat. No. 6,096,194. Faujasite is the most preferred zinc exchanged zeolite.

Preferably, the zeolite comprises a three-dimensional zeolite characterized by pore openings whose smallest cross-sectional dimension is at least about five Angstroms and having a silicon to aluminum atomic ratio of less than 5.

Preferred zeolites are X, Y and faujasite, which are preferably exchanged with zinc. More preferred is zinc exchanged faujasite; with the most preferred zeolite being zinc exchanged faujasite as described in U.S. Pat. No. 6,096,194 which is herein incorporated by reference.

The zeolite compound can be used in suitable form, including powder or pellet form. For example the zeolite can be extruded into pellets and the pellets used in a bed through which the gas passes. Alternatively, a zeolite composition is formed into an aqueous slurry and the slurry coated on a suitable substrate. Preferably, the zeolite compound can be formed into a composition which can be coated as one or more layers on a monolithic substrate generally which can comprise a loading of from about 0.50 to about 5.0, preferably about 0.5 to about 2.0 g/in³ of catalytic composition per layer based on grams of composition per volume of the monolith.

A slurry containing the zeolite components and various other optional additives such as binders, stabilizers and the like, can be comminuted as a slurry to provide solid particles that are advantageously primarily of a size of less than about 15 microns. The slurry can be used to coat a macrosize carrier, typically having a low surface area, and the composite is dried and may be calcined. In these catalysts the composite of the precious metal component and high area support exhibits strong adherence to the carrier, even when the latter is essentially non-porous as may be the case with, for example, metallic carriers, and the catalysts have very good catalytic activity and life when employed under strenuous reaction conditions.

Any suitable carrier may be employed, such as a monolithic carrier of the type having a plurality of fine, parallel gas flow passages extending therethrough from an inlet or an outlet face of the carrier, so that the passages are open to fluid flow therethrough. The passages, which are essentially straight from their fluid inlet to their fluid outlet, are defined by walls on which the catalytic material is coated as a “washcoat” so that the gases flowing through the passages contact the catalytic material. The flow passages of the monolithic carrier are thin-walled channels which can be of any suitable cross-sectional shape and size such as trapezoidal, rectangular, square, sinusoidal, hexagonal, oval, circular. Such structures may contain from about 60 to about 600 or more gas inlet openings (“cells”) per square inch of cross section. The ceramic carrier may be made of any suitable refractory material, for example, cordierite, cordierite-alpha alumina, silicon nitride, zircon mullite, spodumene, alumina-silica magnesia, zircon silicate, sillimanite, magnesium silicates, zircon, petalite, alpha alumina and aluminosilicates. The metallic honeycomb may be made of a refractory metal such as a stainless steel or other suitable iron based corrosion resistant alloys.

Such monolithic carriers may contain up to about 600 or more flow channels (“cells”) per square inch of cross section, although far fewer may be used. For example, the carrier may have from about 60 to 600, more usually from about 200 to 400, cells per square inch (“cpsi”).

The present invention is illustrated further by the following examples which are not intended to limit the scope of this invention.

### EXAMPLES

### Example 1

A zeolite can be tested for removal of sulfur in HD-5 LPG over the temperature range of 25-150° C. In all cases, the weight of zeolite is taken as is (the weight of the zeolite taken without adjustment for adsorbed water content). A useful zeolite for this Example is the zeolite recited in Example 1 of U.S. Pat. No. 6,096,194. Differential thermal analysis shows that the zeolites contained about 20% by weight of water after exposure to room air. A bed of zeolite extrudates is made consisting of a packed zeolite bed contained in a one inch diameter quartz tube, supported either with a fritted disk or glass wool. The zeolite bed is heated to 250° C. to remove moisture. In the first case, sulfur compound removal (adsorption) is evaluated using 4 g of ⅛ inch zeolite extrudates with 1 LPM of LPG. This converts to a whsv of 15,000/hr. The uptake versus T is shown in Table I. “whsv” is the volume of gas passing through the bed on an hourly basis, divided by the weight of the zeolite.

TABLE I

| | % Sulfur removal |
|---|---|
| Temperature, ° C. | (Initial) |
| 30 | 60 |
| 50 | 61 |
| 75 | 72 |
| 100 | 76 |

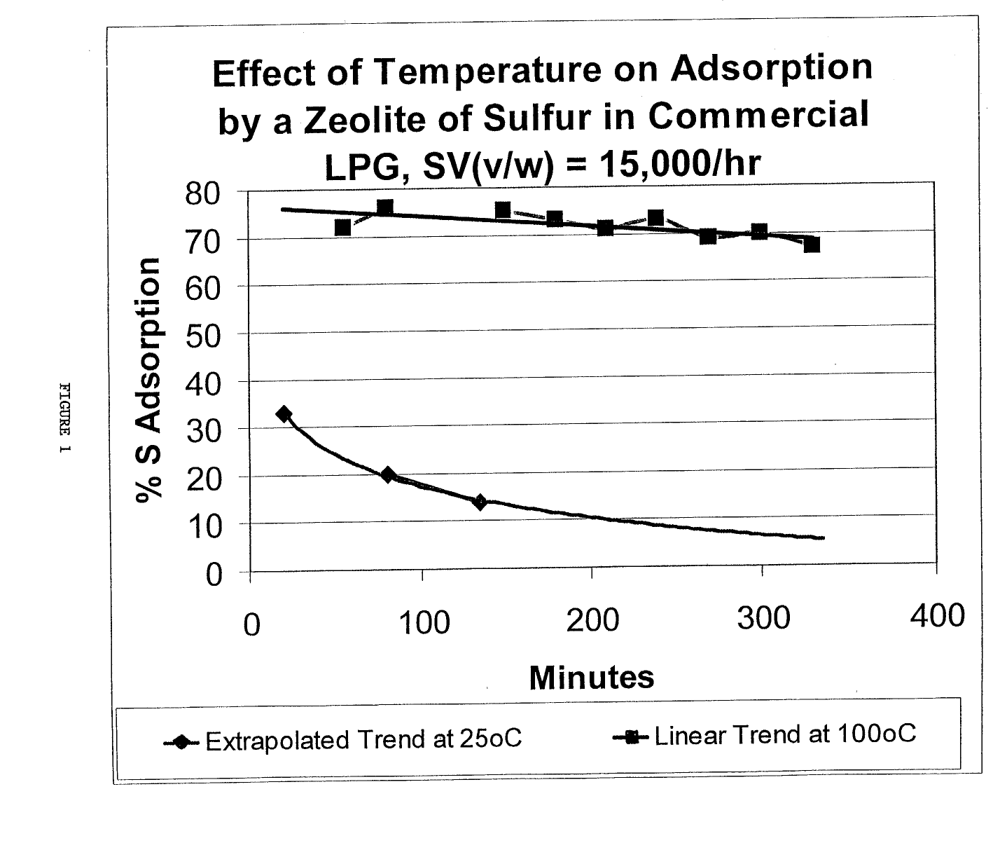

The experiment can be continued, with data accumulated at 100° C. for about four hours. The experiment is repeated in a second run, using fresh sample and data is accumulated at 25° C. for two hours. A trend is predicted based on the decay of performance. The data for the two runs are compared in FIG. 1. FIG. 1 shows that contrary to expectation adsorption occurs at 100° C.

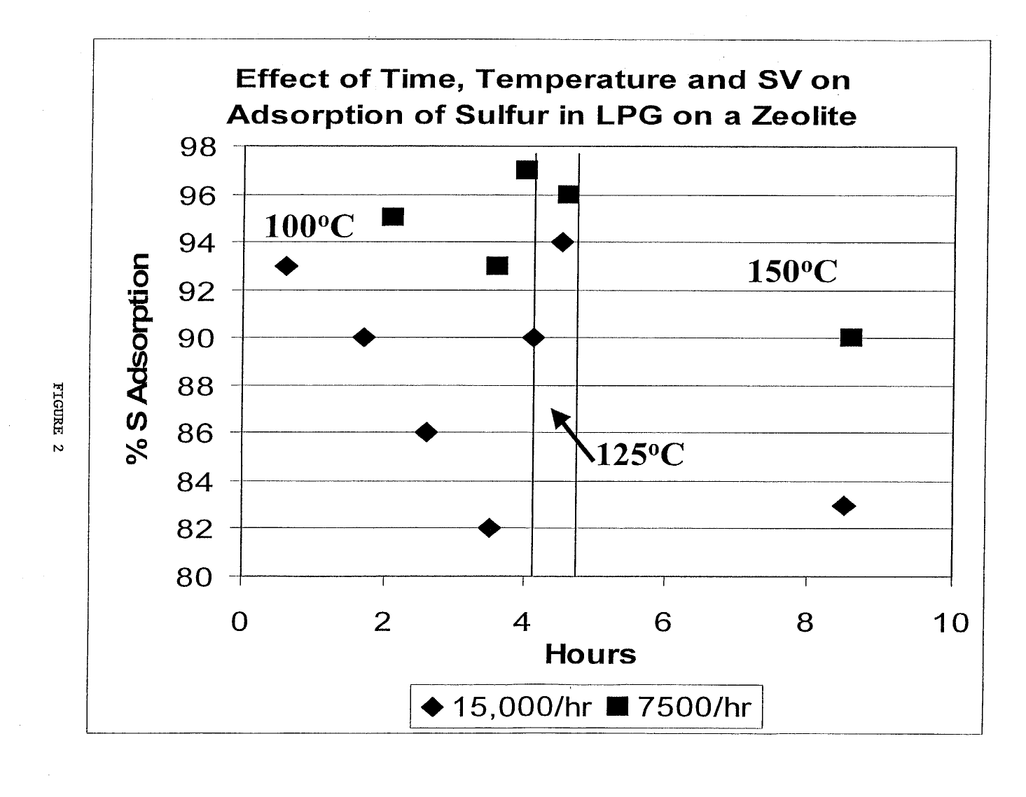

In a third run, a bed of 16 g of a zeolite is exposed to LPG at 100° C. The whsv alternated between 7500 and 15,000/hr. After four hours, the temperature is raised to 125° C., then to 150° C. The latter temperature is held for an additional four hours. After the eight-hour trial, sulfur is still adsorbed effectively, with 83 and 90% of the sulfur compounds removed at 7500 and 15,000/hr whsv, respectively. A total sulfur analyzer is used. Sample is removed from the top of the bed. The tube is tipped and some sample is extracted at about the mid-point. The process continued, then particles from the bottom of the bed were saved. The three vertical fractions can be analyzed. The data is summarized in FIG. 2, and in Table II shows that the sulfur compounds are concentrated at the top of the bed, explaining the consistent adsorption results obtained over eight hours.

TABLE II

| Section | % sulfur |
|---|---|
| Top | 0.084 |
| Middle | 0.013 |
| Bottom | <0.08 |

In a fourth run, four sections of 4 g of a zeolite extrudate bed, pre-heated at 250° C., are exposed to LPG at 100° C. and a whsv of 15,000. Over the course of two days, with a combined exposure of 14.5 hours, the zeolite consistently removes greater than 95 percent of sulfur. Table III shows the distribution of sulfur in the beds after the test.

TABLE III

| Section | % sulfur |
|---|---|
| Top | 0.437 |
| #2 | 0.221 |
| #3 | 0.132 |
| Bottom | 0.184 |

### Example 2

Samples of X zeolite were tested as organic sulfur adsorbents. The first material tested was TOSPIX 94®, a zeolite made by Tokyo Gas. Initial screening of this material at room temperature with no pre-heating showed removal of 30% of sulfur from natural gas and <10% of the sulfur in LPG, respectively. A bed of four 4-g sections, first dried by heating to 250° C., was exposed to 4 LPM of LPG. Based on experience gained with other samples, the effectiveness of TOSPIX 94® was evaluated from 30-175° C. The zeolite exhibited a strong dependence on temperature in sulfur removal. At the same time, the low capacity of this zeolite for sulfur results in a rapid change in the measured uptake. After two hours, the reactor exhibited sulfur desorption at 30-75° C. At 100° C., adsorption was ˜25%,and about 50% of the sulfur was adsorbed in the range of 125-150° C. At 175° C., the adsorption was less than 25%.

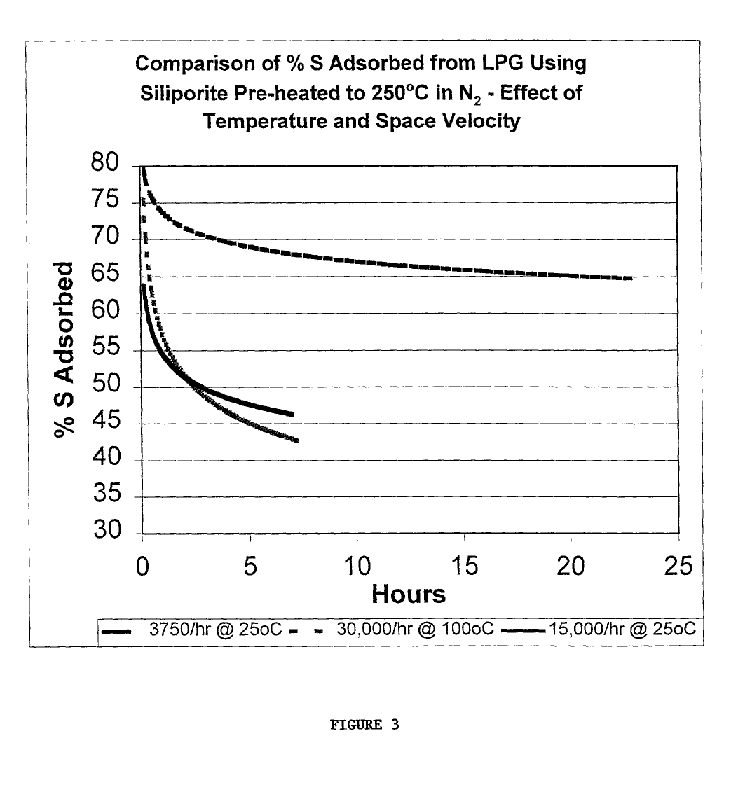

Experiments were also performed with another X zeolite, SILIPORITE®, manufactured by Elf-Atochem. Without thermal pre-treatment, this zeolite adsorbed >95% of sulfur from methane, but only 38% of sulfur from LPG at room temperature at a whsv of 30,000/hr. The material was re-tested with pre-treatment drying for about one hour at 250° C. Run at a whsv of 15,000/hr, the zeolite adsorbed about 57% of sulfur from LPG at room temperature. However, it was shown that the efficiency of sulfur removal increased as temperature rose to 100° C. At 15,000/hr, percent sulfur adsorption of 62, 67, 84 and 88% was measured at temperatures of 25, 50, 75 and 100° C., respectively. When the zeolite was tested at 30,000/hr at 100° C., the sulfur uptake was shown to decrease from 67% to 42 after seven hours. In another experiment, the zeolite X was tested at 15,000/hr at 25° C., and sulfur removal decreased from 63 to 44%. The distribution of sulfur in the zeolite bed was determined, along with sulfur adsorption efficiency, using a four section bed of 4 g each run at 3750/hr at 25° C. The adsorption decreased from 88 to 65% over a 24-hour period. Table IV shows the concentration of sulfur measured in the four sections. The spread of sulfur throughout the zeolite bed explains the drop-off in sulfur adsorption. FIG. 3 compares the change in sulfur pickup as a function of time with different operating conditions.

TABLE IV

| Section | % Sulfur |
|---|---|
| Top | 0.204 |
| #2 | 0.173 |
| #3 | 0.145 |
| Bottom | 0.138 |

### Example 3

The use of monoliths coated with zeolite is evaluated for adsorption of organic sulfur is also evaluated. A : x 1.5″ monolith sample, having 400 cells per square inch (cpsi) containing 3 g/in³ (˜2 g of zeolite washcoat) of zeolite is pre-heated to 250° C. The monolith is cooled to ambient temperature and exposed to 1 LPM of LPG. This corresponds to a volume space velocity of 6000/hr and a whsv of 30,000/hr. Less than 50% of the sulfur is adsorbed. The temperature is then raised to 125° C. Over the next hour, the adsorption rate is constant at 70-75%. Also, the sensitivity to space velocity (SV) is tested. The adsorption rate is fairly constant as the flow increased to 2 LPM, but decreased by a third as the flow rate increased to 4 LPM. After two hours, the monolith showed definite loss of capacity through the measured decrease of sulfur adsorption.

### Example 4

It is beneficial to use the same adsorbent to remove odorants from both natural gas and LPG. The behavior of a zeolite is evaluated for its applicability to desulfurization of natural gas. It is shown that a temperature dependency exists for this application. After pre-heating to 250° C., a 4 g bed of 1/16″ extrudates is exposed to a flow of natural gas at 2 LPM, or a whsv of 30,000/hr. After temperature screening and preliminary aging, the sulfur adsorption is measured as the temperature is incrementally reduced from 175 to 50° C. The data shows almost constant percent adsorption over the range of 100-175° C.

What is claimed is:

1. A method to remove sulfur compounds from a gas comprising up to about 30 percent propylene comprising contacting the gas with a zeolite compound at greater than 75° C., wherein the zeolite compound comprises less than 5 percent water.

2. The method as recited in claim 1 further comprising the step of predrying the zeolite compound at a temperature of from 125 to 300° C.

3. The method as recited in claim 2 further comprising the step of predrying the zeolite compound at a temperature of from 150 to 300° C.

4. The method as recited in claim 1 further comprising the step of contacting the gas with a zeolite compound at a temperature of from greater than 75° C. to 200° C.

5. The method as recited in claim 4 further comprising the step of contacting the gas to be treated with a zeolite compound at a temperature of from greater than 75° C. to less than 150° C.

6. The method as recited in claim 1 further comprising the step of contacting the gas to be treated with a zeolite compound at a temperature of from greater than 75° C. to 125° C.

7. The method as recited in claim 1 wherein the zeolite is ion exchanged with zinc ions.

8. The method as recited in claim 7 wherein the zeolite is selected from the group consisting of X, Y and faujasite.

9. The method as recited in claim 8 wherein at least 8 percent of the zinc ions are present in inequivalent excess of the total ion exchange degree of the zeolite.

10. The method as recited in claim 1 wherein the zeolite is faujasite.

11. The method as recited in claim 10 wherein the silica to alumina ratio is from about 1.8:1 to about 2.1:1.

12. The method as recited in claim 1 wherein the zeolite is selected from the group consisting of X, Y and faujasite.

13. The method as recited in claim 12 wherein the zeolite is faujasite.

14. A method to remove sulfur compounds from a feed gas to a fuel reformer, the feed gas comprising up to about 30 percent propylene comprising the steps of: contacting the gas with sufficient zeolite compound at greater than 75° C., wherein the zeolite compound comprises less than 5 percent water, to remove at least 95% of the incoming gaseous sulfur compounds to form a desulfurized gas stream; and feeding the desulfurized gas stream to the fuel reformer.

15. The method as recited in claim 14 wherein desulfurized gas stream contains less than 0.5 ppm of the sulfur compounds.
